(19) United States
(12) Patent Application Publication
(10) Pub. No.: US 2016/0011882 A1
(43) Pub. Date: Jan. 14, 2016

(54) RESOURCE ADVISOR FOR AUTOMATED BARE-METAL OPERATING SYSTEM INSTALLATION

(71) Applicant: Lenovo Enterprise Solutions (Singapore) PTE. LTD., Singapore (SG)

(72) Inventors: Jarrod B. Johnson, Raleigh, NC (US); Niraj D. Dinesh, Rochester, MN (US); Andrew J. Sloma, New Braunfels, TX (US)

(21) Appl. No.: 14/329,908

(22) Filed: Jul. 12, 2014

(51) Int. Cl. G06F 9/44; G06F 21/44; G06F 9/445

(52) U.S. Cl. CPC G06F 9/4406; G06F 8/61; G06F 21/44

(57) ABSTRACT

Systems and methods for a resource advisor for automated bare-metal operating system installation is disclosed herein. According to an aspect, a method comprising using at least one processor and memory for detecting available resources in a computing device. Further, the method comprises validating resource criteria specified by a user. Further, the method, in response to validating the resource criteria, generating a list of recommended resources for installing an operating system based on the detected available resources.

### BACKGROUND

1. Field of the Invention

The present invention is related to resource advising, and more specifically, to systems and methods for a resource advisor for automated bare-metal operating system installation.

2. Description of Related Art

A data center is a facility used to house computer systems, networks and associated components, such as telecommunications and storage systems. A data center generally includes redundant or backup power supplies, redundant data communications connections, environmental controls, and various security devices. Modern data centers include very complex computing, networking, and storage resources including both hardware and software. Typically, each of these hardware and software resources require specific configurations in order to communicate properly within the data center and external to the data center network. Many of these configuration settings require very precise knowledge by the data center administrators of the network and storage infrastructure as well as special requirements for inter-operability between the computer systems and associated components. Data center administrators must also be aware of the disparate management interfaces that are needed to configure these various components.

The computer systems and the associated components in data centers serve the needs of many computing needs and/or many users, often times the computing needs are virtualized. Virtualization refers to the creation of a virtual (rather than actual) version of a resource, such as an operating system (OS), a server or a network resource. A virtual machine is typically a multi-user shared-resource OS that gives each user the impression of having sole control of all computer or network resources. A bare-metal environment is a computer system or network in which a virtual machine is installed directly on hardware rather than within the host OS. The term “bare-metal” refers to a hard disk, the typical medium on which a computer system's OS is installed.

Administrators that may be responsible for installation of operating systems to bare-metal computer systems or servers must not only be aware of the configuration of these computer systems and associated components, but more specifically the administrators must be aware of specific types and the associated function of various input/output (I/O) hardware and software resources installed within the data center. Further, the administrators must also be aware of the configuration of the operating system to be deployed to the computer system or compute node. The virtual machine or the operating system image being installed in a bare-metal configuration requires network and storage configuration in order to leverage the I/O resources that were previously configured and managed by an underlying operating system in a virtual environment. For successful bare-metal installation, the bare-metal OS network and storage configuration must be configured by the administrator via potentially several different system management interfaces. If these resources are not configured properly then the installation of the operating system to the computer system or compute node will fail or partially fail.

In view of the foregoing, there is a need for improved systems and methods for a resource advisor for automated bare-metal operating system installation.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for a resource advisor for automated bare-metal operating system installation. According to an aspect, a method comprises using at least one processor and memory for detecting available resources in a computing device. Further, the method comprises validating resource criteria specified by a user. Further, the method, in response to validating the resource criteria, generating a list of recommended resources for installing an operating system based on the detected available resources.

According to another aspect, a method comprises using at least one processor and memory for detecting available resources in a bare-metal computing device. The method also includes determining whether resource criteria specified by a user is not valid. Further, the method includes generating a notification that specifies a valid resource criteria in response to determining that the resource criteria specified by the user is not valid.

### BRIEF DESCRIPTION OF THE SEVERAL VIEWS OF THE DRAWINGS

FIG. 1 is a block diagram of an example system for a resource advisor for automated bare-metal operating system installation in accordance with embodiments of the present invention;

FIG. 2 is a flowchart of an example method for a resource advisor for automated bare-metal operating system installation in accordance with embodiments of the present invention;

FIG. 3 is an example of a system management user interface for input of user defined I/O resource criteria in accordance with embodiments of the present invention; and

FIG. 4 is an example of an end to end process flow for a resource advisor for automated bare-metal operating system installation in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. In another example, a computing device may be a server or other computer and communicatively connected to other computing devices (e.g., handheld devices or computers) for data analysis. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

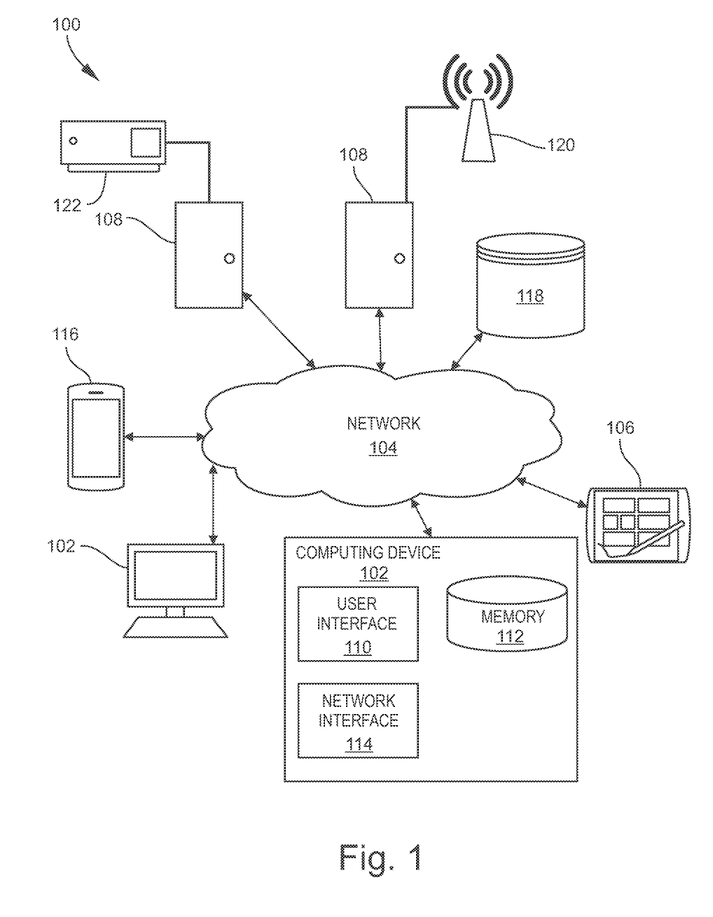

The presently disclosed invention is now described in more detail. FIG. 1 illustrates a block diagram of a system 100 according to embodiments of the present invention. The system 100 may be implemented in whole or in part in any suitable environment. The computing devices 102 may each be communicatively connected via a communications network 104, which may be any suitable local area network (LAN), either wireless (e.g., BLUETOOTH® communication technology) and/or wired. The computing device 102, a tablet device 106 in communication with one of the computing devices 102, and other components, not shown, may be configured to acquire data within the computing environment, to process the data, and to communicate the data to a centralized server 108. For example, the computing device 102 and its tablet device 106 may operate together to implement a search analysis function and to communicate data related thereto to the server 108 using a user interface 110.

The components of the system 100 may each include hardware, software, firmware, or combinations thereof. For example, software residing in memory of a respective component may include instructions implemented by a processor for carrying out functions disclosed herein. The computing device 102 may also include memory 112. The computing device 102 may also include a suitable network interface 114 for communicating with the network 104. The system 100 may also include a smart phone device 116 configured with functionality similar to the tablet device 106. The system 100 may also include a database 118 for storage of search inquiries, web sites and other similar data. Further, for example, the server 108 may be connected to the computing devices 102 via the network 104 or via a wireless network 120.

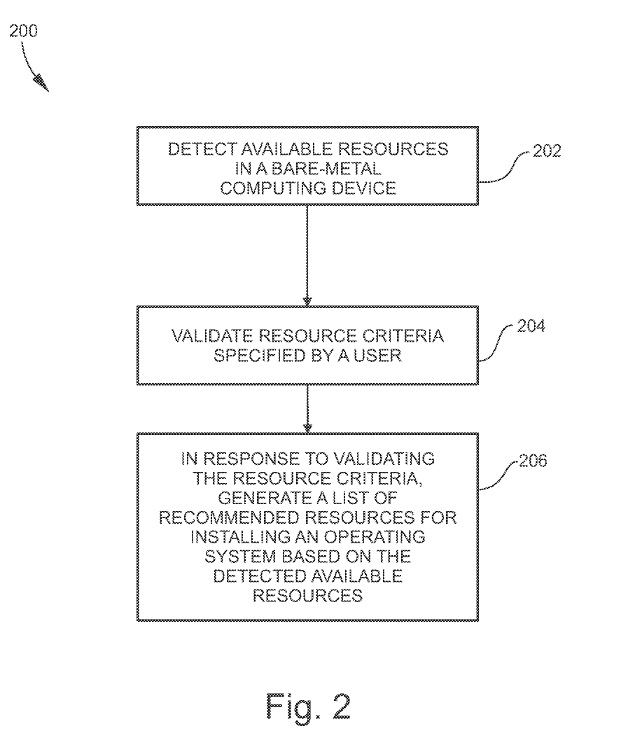

FIG. 2 is a flowchart of an example method for a resource advisor for automated bare-metal operating system installation in accordance with embodiments of the present invention. It is noted that reference is made to FIG. 1 as implementing the example method described in FIG. 2, although it should be understood that any suitably configured system can implement the method of FIG. 2.

With continued reference to FIG. 2, the method 200 comprises using at least one processor and memory for providing intelligent resource advisory software including several key capabilities for automating operating system deployment. The method 200 includes detecting 202 available resources in a bare-metal computing device 102 or server 108. The available resources may include the network interface 114 or memory 112 as examples. The available resources may also include network based or locally installed storage devices. The method 200 detects available resources in the computing device 102 or server 108, such as an I/O resource detection mechanism. As an example, detecting available resources may include detecting visible storage area network (SAN) storage volumes, available network interfaces or available local storage devices (hard disk drives, solid state drives, etc.).

With continued reference to FIG. 2, the method 200 may be used in conjunction with other systems management software technologies. The systems management software technologies may present server configuration patterns to the user with intelligent defaults as part of the operating system deployment pre-validation. The pre-validation may be based on repeatable server configuration patterns that can be leveraged by systems management software. The repeatable server configuration patterns may be predetermined by the systems management software or programmed into the system by a user, administrator, the server 108, or the computing device 102. The server configuration patterns can be used to either generate a new set of configuration settings to be grouped into a configuration pattern, or generate a configuration pattern from an existing server configuration pattern. The server configuration pattern harnesses the knowledge of systems management software (such as hardware inventory, network topology, available storage, as examples) to present to the administrator or user potential configuration settings for specification or use in the repeatable server configuration pattern. Repeatable server configuration patterns may be leveraged by the method 200 by the resource advisor. The method 200 may subsequently intelligently present to the administrator or user the OS deployment compliant settings as well as intelligent configuration defaults. In this manner, preempting OS deployments which may have configuration settings that fail at deployment, as an example. As described herein, preempting failures with OS deployment decreases the time that may be needed for the administrator or user OS installation and deployment on computing devices, servers or other similar devices. This may result in a streamlining of the end-to-end process of configuring the server firmware, I/O components, and bare-metal operating system. For example, if a user leverages a server configuration pattern to specify an existing storage volume for use with the bare-metal OS targeted for deployment, the method 200 or resource advisor may validate the server 108 or computing device 102 has access to the desired storage device before deploying the operating system. If it does not have access, the resources advisor may recommend a storage volume which is accessible or indicate that the specified storage volume may require additional zoning or allocation prior to the operating system deployment.

With continued reference to FIG. 2, the method 200 may include validating 204 resource criteria specified by a user. As an example, an I/O resource criteria validation mechanism may include validating a given Internet protocol (IP) address allowing network communication to the management server from the bare-metal server or computing device 102. An additional example, may be to validate a given storage volume is zoned and visible to the bare-metal server. The bare-metal server may be the server 108 or the computing device 102. Additionally, the method 200 may validate a given storage volume contains enough space to meet the requesting user's needs. In this manner, the method 200 could be used for compliance checking of user specified configuration settings. For example, if a user specifies a particular IP address and media access control (MAC) address for the operating system deployment, the method 200 may validate the IP and MAC address are configured to provide network connectivity prior to the operating system deployment. If validation fails, then it may be determined the configuration is out of compliance and the user may be notified prior to deploying the operating system to the bare-metal server or computing device 102. Part of the notification may include a recommendation by the method 200 regarding network settings which may be used for the desired network connectivity. The recommendations by the method 200 may be based on predetermined resource criteria or configurations. The predetermined resource criteria may be based on actual detected configurations or programmed configurations.

With continued reference to FIG. 2, the method 200, in response to validating 204 the resource criteria, may generate 206 a list of recommended resources for installing an operating system based on detecting 202 available resources. Given the validation of the user's resource criteria and the actual detected I/O resources, the method 200 may provide advice on which resources should be leveraged to meet the resource usage criteria defined by the user.

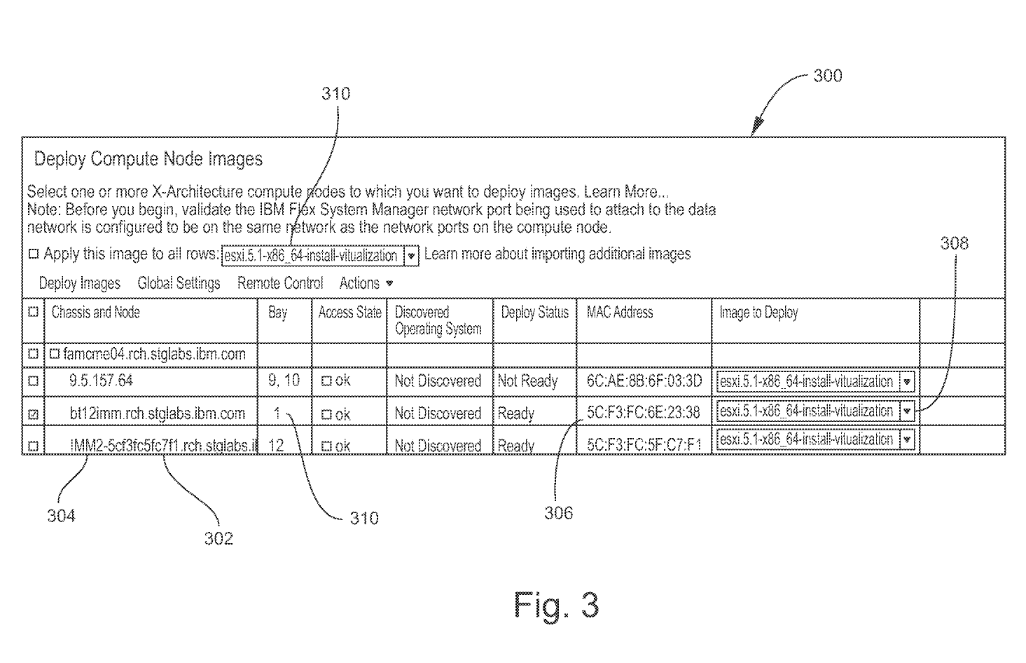

FIG. 3 is an example of a system management user interface 300 for input or selection of user specified resource criteria in accordance with embodiments of the present invention. As disclosed herein, the user specified resource criteria may be I/O resource criteria or other servers 108 or computing devices 102. The user specified resource criteria 302 may also be predetermined resource criteria 302 selected based on system management discovery and inventory data. The predetermined resource criteria 302 may be selected using check boxes 304, drop down menus or other suitable mechanism for item selection in the user interface 300. Additionally, the user may manually input the resource criteria specifying the resources to use for the OS installation. As an example, FIG. 3 shows an inventory of available resources 304 discovered by the resource advisor or system management software. In this example, the resource criteria being specified by the user is the configuration of MAC address 5C:F3:FC:6E:23:38 306 for use with the VMWare ESXi operating system deployment 308 on the bare-metal server in Bay 1 310.

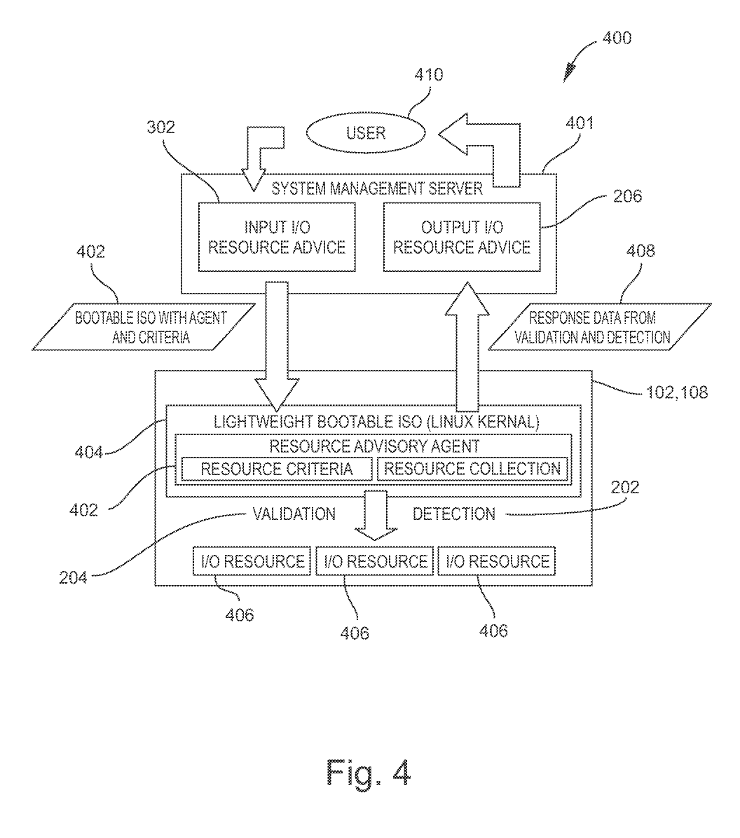

FIG. 4 is an example of an end-to-end process flow 400 of the resource advisor for automated bare-metal operating system installation in accordance with embodiments of the present invention. As an example, once the user specified resource criteria 302 is provided, the system management server 401 takes the bare-metal operating system deployment criteria 308 and a resource advisory agent 402 may generate a light weight bootable operating system 404. The light weight bootable operating system 404 may be a Linux kernel, as an example, though any suitable operating system may be used. The light weight bootable OS 404 is then mounted to the bare-metal server 102, 108 and the bare-metal server 102, 108 is rebooted to boot to this mounted light weight bootable OS 404. Once the bare-metal server 102, 108 boots to the mounted light weight bootable OS 404, the resource advisory agent 402 is executed. A light weight bootable OS 404 may be a relatively small and minimally configured bootable OS. Based on the provided user specified resource criteria 302, the resource advisory agent 402 may be configured to interrogate the network and storage resources 406 on the bare-metal server 102, 108. In this manner the advisory agent 402 may perform a validation by validating the user specified resource criteria 302 as compared to the detection of the network and storage resources 406. The resource advisory agent 402, may then be configured to provide 408 a recommendation of the best resources for use with the operating system 308. This recommendation may then be provided to the system management server 401 and provided to the user 410. Once the user 410 approves of the resource advisor agents 402 recommendations the system management server 401 may deploy the requested operating system 308 to the bare-metal server 102, 108 using the resource advisor's 402 recommended configuration settings.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
using at least one processor and memory for:
detecting available resources in a bare-metal computing device;
validating resource criteria specified by a user; and
in response to validating the resource criteria, generating a list of recommended resources for installing an operating system on the bare-metal computing device based on the detected available resources.

2. The method of claim 1, further comprising receiving at least one predetermined resource criteria for user specification.

3. The method of claim 2, further comprising providing at least one of the predetermined resource criteria for specification.

4. The method of claim 2, wherein the at least one predetermined resource criteria for user specification is based on an existing bare-metal computing device configuration.

5. The method of claim 1, wherein the detected available resource is one of a storage volume and a network interface.

6. The method of claim 1, wherein the validated resource criteria is an Internet protocol (IP) based address allowing network communication to a server.

7. The method of claim 1, wherein the validated resource criteria is a storage volume zoned and available to the bare-metal computing device.

8. The method of claim 1, wherein the validated resource criteria is a storage volume having sufficient storage capacity for a specified operating system installation.

9. A system comprising:
a computing device comprising at least one processor and memory, the computing device configured to:
detect available resources in a bare-metal computing device;
validate resource criteria specified by a user; and
in response to validating the resource criteria, generate a list of recommended resources for installing an operating system on the bare-metal computing device based on the detected available resources.

10. The system of claim 9, wherein the computing device is further configured to:
determine whether the resource criteria specified by the user is not valid; and
generate a notification in response to determining that the resource criteria specified by the user is not valid.

11. The system of claim 10, wherein the computing device is further configured to specify a valid resource criteria in the notification.

12. The system of claim 9, wherein the computing device is further configured to receive at least one predetermined resource criteria for user specification.

13. The system of claim 12, wherein the computing device is further configured to provide at least one of the predetermined resource criteria for specification.

14. The system of claim 12, wherein the at least one predetermined resource criteria for user specification is based on an existing bare-metal computing device configuration.

15. The system of claim 9, wherein the detected available resource is one of a storage volume and a network interface.

16. The system of claim 9, wherein the validated resource criteria is an internet protocol (IP) based address allowing network communication to a server.

17. The system of claim 9, wherein the validated resource criteria is a storage volume zoned and available to the bare-metal computing device.

18. The system of claim 9, wherein the validated resource criteria is a storage volume having sufficient storage capacity for a specified operating system installation.

19. A method comprising:
using at least one processor and memory for:
detecting available resources in a bare-metal computing device;
determining whether resource criteria specified by a user is not valid; and
in response to determining that the resource criteria specified by the user is not valid, generating a notification that specifies a valid resource criteria.

20. The method of claim 19, further comprising receiving at least one predetermined resource criteria for user specification.
